(19) United States
(12) Patent Application Publication
(10) Pub. No.: US 2022/0333737 A1
(43) Pub. Date: Oct. 20, 2022

(54) HELMET

(71) Applicant: DYNAMIXYZ, Cesson-Sévigné (FR)

(72) Inventor: Gaspard Breton, Cesson-Sévigné (FR)

(21) Appl. No.: 17/723,931

(22) Filed: Apr. 19, 2022

(30) Foreign Application Priority Data
Apr. 19, 2021 (EP) 21305517.1

(51) Int. Cl. F16M 13/04; H04N 5/225; G03B 17/56

(52) U.S. Cl. CPC F16M 13/04; H04N 5/2251; G03B 17/561

(57) ABSTRACT

The invention relates to a head mounted image capture device (101) for capturing facial motion of a user. The device (101) includes a helmet (102) including a front portion (103) for resting on the user's forehead, a back portion (104) for resting on the back of the user's head and side portions (105) each for resting on the sides of a user's head (H). Each side portion (105) includes a respective arm (106) which supports a respective camera (107). The device (101) also includes an articulated structure (109) connecting the front portion (103) to the back portion (104) for approximating the profile of the head (H) of the user.

This application claims priority to European Patent Application No. EP21305517.1, filed on Apr. 19, 2019, which application is herein expressly incorporated by reference, in its entirety.

### FIELD OF THE INVENTION

This invention relates generally to helmets, particularly adaptable helmets. More specifically, although not exclusively, this invention relates to an adaptable helmet for supporting image capture equipment for capturing facial motion of a user.

### BACKGROUND OF THE INVENTION

Facial motion capture is the process of converting the movements of the face of an actor into a digital database using image capture equipment and/or laser scanners. This database may then be used to produce computer graphics, computer animation for movies, games, or real-time avatars. This process results in a more realistic and nuanced computer character animation because the motion of the computer graphic character is derived from the movements of a real person.

A facial motion capture database describes the coordinates of reference points on the actor's face. The capture can be in two or three dimensions. Two-dimensional capture can be achieved using a single camera and capture software. This produces less sophisticated tracking, and is unable to capture fully three-dimensional motions, such as head rotation. Three-dimensional capture is accomplished using multi-camera rigs or laser marker systems. These systems are much more expensive and complicated to use.

EP2340646A1 describes a head-mounted camera system that captures an actor's facial movements separately from, but simultaneously with, the movements of the actor's body. Multiple cameras are mounted to a helmet worn by the actor via a pair of rods rotatably mounted to the helmet.

Such known head mounted camera systems generally incorporate adjustable straps, which provide adaptability to accommodate the differing sizes and shapes of the heads of actors.

However, these known arrangements are difficult to secure rigidly and repeatably to the head of the actor, and can sometimes result in unwanted movement of the cameras relative to the actor's face.

In addition, these conventional devices do not allow the cameras to be identically repositioned relative to the face when the user re-installs the helmet after temporarily removing it. Thus, it is necessary to recalibrate the image capture system each time the user wants to remove and re-install the helmet, which can happen several times a day.

It would therefore be advantageous to provide an adaptable helmet for supporting image capture equipment for capturing facial motion, which mitigates the issues with known systems.

### SUMMARY OF THE INVENTION

The invention provides a head mounted image capture device for capturing facial motion of a user, the device comprising a helmet including: at least two side portions, each for resting on one side of the user's head, each side portion may comprise an arm for supporting at least one camera; a front portion for resting on the user's forehead; a back portion for resting on the back of the user's head; characterized in that the device also includes an articulated structure connecting the front portion to the back portion for approximating the profile of the user's head.

The provision of an articulated structure that approximates the profile of a user's head facilitates more precise repositioning of the device, and cameras mounted to the device, when the device is re-installed on the user after temporarily removing it. This mitigates the aforementioned recalibration issues.

The articulated structure may comprise at least two members, for example a plurality of members. The members may be connected or linked together, e.g. pivotally, and/or in series. The members may be connected or linked together by fasteners or fixings. The fasteners or fixings may enable the angular position of the members to be adjusted relative to one another.

The device may comprise a cushion. The cushion may extend along at least part of the articulated structure. The cushion may be mounted to one or more or each of the members, e.g. for supporting the articulated structure on the user's head.

At least one or each member may comprise a cushion support member to which the cushion may be mounted. The or each or at least one of the cushion support members may comprise or may be a cushion support plate.

One end, e.g. a first end, of the cushion may be mounted to the front portion. One end, e.g. a second end, of the cushion may be mounted to the back portion.

The cushion may comprise or contain a flexible substance, such as a foam or a gel.

The back portion may comprise a strap or cord. The strap or cord of the back portion may be connected to at least one or each side portion. The strap or cord of the back portion may be elasticated. The back portion may comprise at least one locking slot. The locking slot may be for releasably retaining a portion of the elasticated strap or cord, e.g. to enable adjustment of its length.

The device may comprise a top portion, which may be for resting on top of the user's head. The top portion may comprise a locating means, e.g. for locating the articulated structure relative to the top portion. The locating means may comprise a recess, cut out or receptacle, for example to receive part of the articulated structure, or within which the articulated structure is received.

The top portion may comprise a strap or cord. The strap or cord of the top portion may be connected to at least one or each side portion. The strap or cord of the top portion may have an adjustable length. At least one or each end of the strap or cord of the top portion may be secured or securable to one of the side portions.

At least one or each end of the strap or cord of the top portion may be releasably secured to one of the side portions, for example to enable adjustment of its length. The or each end of the strap or cord of the top portion may be releasably secured to one of the side portions by a fastener, e.g. a threaded fastener. The top portion may comprise at least one slot, for example along at least part of its length. The top portion may comprise a slot adjacent the or each of its ends through which the fastener extends, e.g. to enable the length of the strap or cord to be adjusted.

The front portion may comprise a strap or cord. The strap or cord of the front portion may be connected or linked together to at least one or each side portion. The strap or cord of the front portion may have an adjustable length. At least one or each end of the strap or cord of the front portion may be secured or securable to one of the side portions.

At least one or each end of the strap or cord of the front portion may be releasably secured to one of the side portions, for example to enable adjustment of its length. The or each end of the strap or cord of the front portion may be releasably secured to one of the side portions by a fastener, e.g. a threaded fastener.

At least one or each arm may be movable, for example rotatable, relative to the side portion. At least one or each side portion and/or at least one or each arm may include at least one visual indicator, e.g. for determining the orientation of the arm to which it is mounted.

The device may comprise at least one camera, which may be mounted to at least one of the arms. The device may comprise an camera mounted to each arm.

The device may comprise a pair of opposed cameras. Each camera may be positioned laterally of a user's face for capturing image data relating to a respective side of the user's face.

The device may comprise a central plane, which may segment the lateral sides of the device. The or at least one or each camera may be oriented such that the angle between its image plane and the central plane is less than 45 degrees, for example less than 30 degrees and preferably less than 20 degrees.

The or each camera may be configured to be substantially aligned with the user's nose.

The or each camera may comprise a video camera and/or may be configured to capture digital data representative of one or more images. The device may comprise a memory or memory device for recording data captured by the camera(s). The device may comprise a processor for controlling the operation of the camera(s) and/or the memory. The device may comprise one or more lighting elements or devices, e.g. for illuminating the face of a user. The processor may be operable to control the lighting element(s) or device(s).

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way, unless such features are incompatible.

For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only with reference to the accompanying drawings in which:

FIG. 1 is a side view of an image capture device;

FIG. 2 is a top view of the device of FIG. 1;

FIG. 3 is a rear view of the device of FIGS. 1 and 2;

FIG. 4 is an upper rear view of the device of FIGS. 1 to 3;

FIG. 5 is a side view similar to that of FIG. 1 with the device mounted on a user's head.

### DETAILED DESCRIPTION OF THE INVENTION

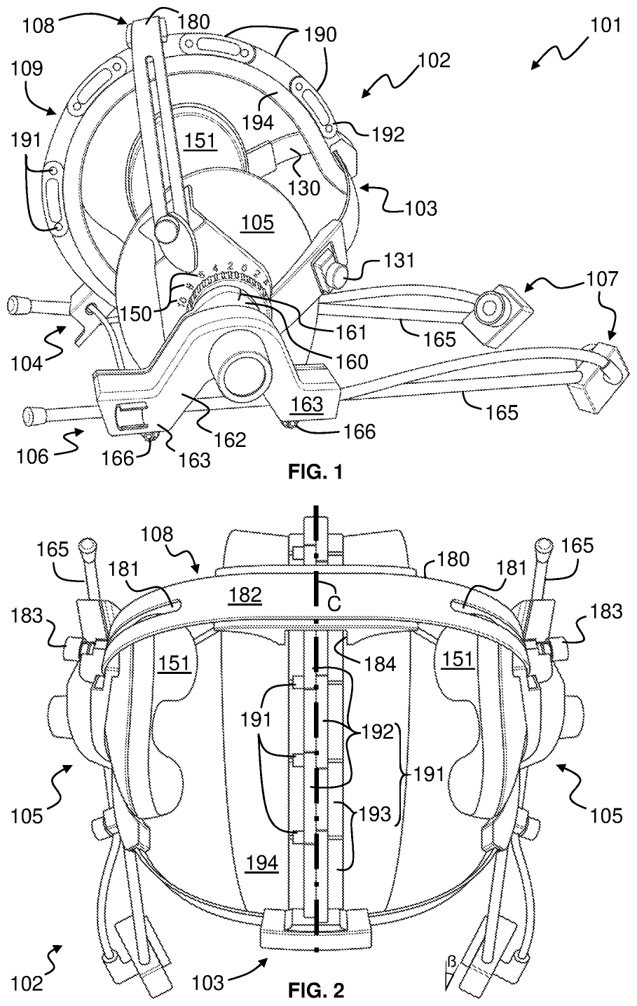

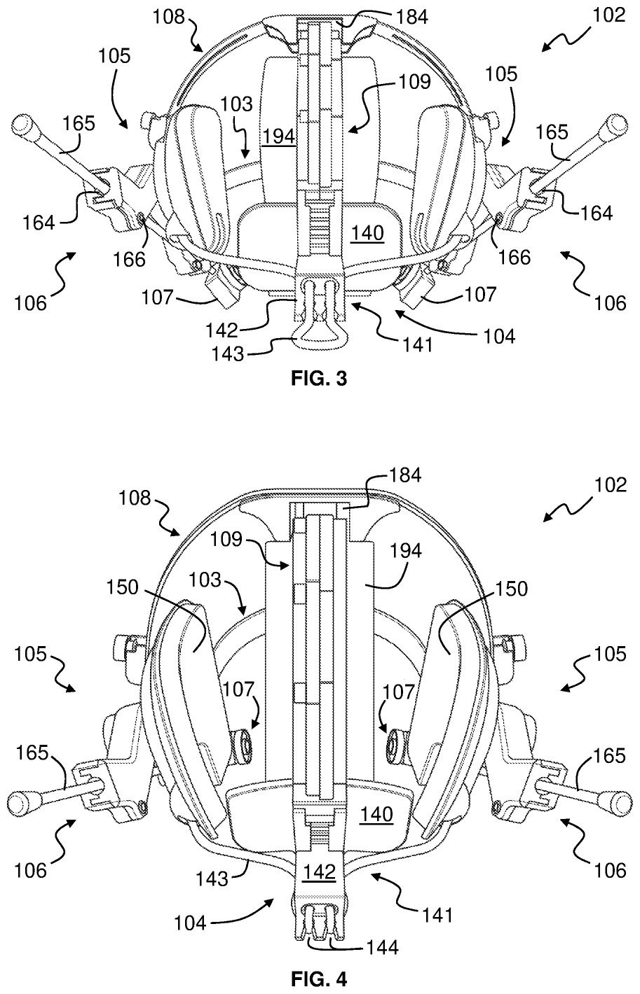

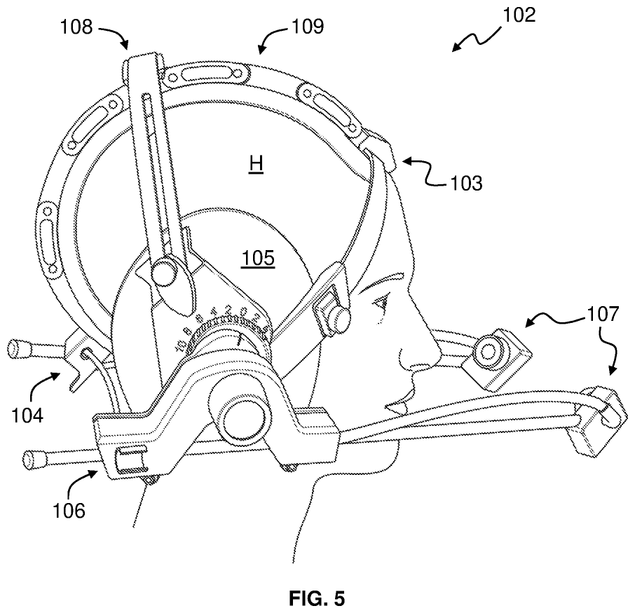

Referring now to FIG. 1, there is shown a head mounted image capture device 101 for capturing facial motion of a user. The device includes a helmet 102 with a front portion 103 for resting on the user's forehead, a back portion 104 for resting on the back of the user's head and a pair of side portions 105, each for resting on the sides of a user's head. Each side portion 105 includes an arm 106 to which a camera 107 is mounted. The device 101 also includes a top portion 108 for resting on top of the user's head H and an articulated structure 109 connecting the front portion 103 to the back portion 104 for approximating the profile of the head of the user.

The front portion 103 in this example includes a semi-rigid plastic strap 130. Each end of the strap 130 is releasably secured to a respective one of the side portions 105 by a clamp 131 to enable adjustment of its length.

The back portion 104 includes a cushion support plate 140 and an adjustment mechanism 141 secured to the rear side of the cushion support plate 140. The adjustment mechanism 141 includes a locking member 142 that is step-wise adjustable toward and away from the articulated structure 109. The back portion 104 also includes an elasticated cord 143 attached at each end to one of the side portions 105. The elasticated cord 143 also extends through a pair of holes in the locking member 142 to form a loop. The locking member 142 includes a pair of locking slots 144 having a necked portion for releasably retaining respective portions of the elasticated cord 143 to enable adjustment of its effective length.

Each side portion 105 includes a series of visual indicators 150, in the form of numbers in this example. Each arm 106 includes a hub 160 with a visual indicator 161, in the form of a line, that cooperates with the visual indicators 150 of the side portion 105 to which it is mounted, to provide an indication of the orientation of the arm 106. This facilitates the configuration of the helmet 102, and also enables the orientation of the arms 106 to be synchronised in a simple manner. Each side portion 105 also includes a cushion 151, which is filled with gel in this example.

Each arm 106 also includes a pair of legs 162 that diverge from one another at an oblique angle. The legs 162 have respective feet 163 that are coaxial with, but extend away from, one another. Each foot 163 includes a hole 164 extending along its length through which a rod 165 of the arm 106 extends. Each leg 162 is formed in two parts, which can be clamped or loosened by bolts 166 and together form a clamp to releasably secure the rod 165 in position.

One of the cameras 107 is mounted to the end of each rod 165 and faces inwardly, toward the other camera 107 but at an angle relative thereto. More particularly, each camera 107 is oriented such that its image plane is at an angle β with respect to a central plane C segmenting the lateral sides of the device 101. In this example, the angle β is approximately 15 degrees, but it is envisaged that the angle may be greater or less than this angle. For example, the angle may be 20 degrees, 30 degrees or even 45 degrees. Similarly, the angle may be 10 degrees, 5 degrees or zero degrees.

The top portion 108 includes a semi-rigid plastic strap 180 with a pair of slots 181, each of which extends from adjacent one of its ends and terminates at a central portion 182 of the strap 180. Each side of the strap 180 is releasably secured to a respective one of the side portions 105 by a threaded fastener 183 that extends through one of the slots 181 and releasably clamps the strap 180 into position to enable adjustment of its length. The top portion 108 also includes a locating slot 184 that receives and locates the articulated structure 109 relative to the top portion 108.

The articulated structure 109 includes a plurality of members 190 pivotally connected together in series by fasteners 191, which enable the angular position of the members 190 to be adjusted relative to one another. In this manner, the articulated structure 109 forms a kind of spine that extends along the central plane C of the helmet 102.

Each member 190 includes a short bar 192 with rounded ends, through which the fasteners 191 go, and a cushion support plate 193. A cushion 194 is provided, which extends along the articulated structure 109 from the front portion 103 to the back portion 104, for supporting the helmet 102 on the user's head. The cushion 194 is mounted at a first of its ends to the front portion 103 and at a second of its ends to the cushion support plate 140 of the back portion 104. The cushion 194 is also mounted to the cushion support plate 193 of each member 190 along its length. The cushion 194 is filled with gel in this example.

It will be appreciated by those skilled in the art that several variations to the aforementioned embodiments are envisaged without departing from the scope of the invention.

1. A head mounted image capture device for capturing facial motion of a user, the device comprising a helmet including:
at least two side portions, each for resting on one side of a user's head; each side portion comprising an arm for supporting at least one camera;
a front portion for resting on the user's forehead;
a back portion for resting on the back of the user's head;
characterized in that the device also includes an articulated structure connecting the front portion to the back portion for approximating the profile of the user's head.

2. The device of claim 1, wherein the articulated structure comprises a plurality of members pivotally connected together in series by fasteners which enable the angular position of the members to be adjusted relative to one another.

3. The device of claim 2 comprising a cushion extending along at least part of the articulated structure and mounted to each of the members for supporting the articulated structure on the user's head.

4. The device of claim 3, wherein each member comprises a cushion support plate to which the cushion is mounted.

5. The device of claim 3, wherein a first end of the cushion is mounted to the front portion and a second end of the cushion is mounted to the back portion.

6. The device of claim 3, in which the cushion contains a gel.

7. The device of claim 1, wherein the back portion comprises a strap or a cord connected to each side portion.

8. The device of claim 7, wherein the strap or cord of the back portion is elasticated and the back portion comprises at least one locking slot for releasably retaining a portion of the elasticated strap or cord to enable adjustment of its length.

9. The device of claim 1, comprising a top portion for resting on top of the user's head, wherein the top portion comprises a locating means for locating the articulated structure relative to the top portion.

10. The device of claim 9, wherein the top portion comprises a strap or a cord connected to each side portion and having an adjustable length.

11. The device of claim 10, wherein each end of the strap or cord of the front portion is releasably secured to one of the side portions to enable adjustment of its length.

12. The device of claim 1, wherein the front portion comprises a strap or a cord connected to each side portion and having an adjustable length.

13. The device of claim 5, wherein the front portion comprises a strap or a cord connected to each side portion and having an adjustable length.

14. The device of claim 7, wherein the front portion comprises a strap or a cord connected to each side portion and having an adjustable length.

15. The device of claim 8, wherein the front portion comprises a strap or a cord connected to each side portion and having an adjustable length.

16. The device of claim 12, wherein the front portion comprises a strap or a cord connected to each side portion and having an adjustable length.

17. The device of claim 12, wherein each end of the strap or cord of the front portion is releasably secured to one of the side portions to enable adjustment of its length.

18. The device of claim 1, wherein each side portion is rotatable relative to the side portion, each side portion and/or arm including at least one visual indicator for determining the orientation of the arm.

19. The device of claim 1, comprising a camera mounted to each arm.

20. The device of claim 18, comprising a camera mounted to each arm.
